(19) United States
(12) Patent Application Publication
(10) Pub. No.: US 2008/0138109 A1
(43) Pub. Date: Jun. 12, 2008

(54) PROCESS CARTRIDGE

(75) Inventors: Osamu Anan, Susono-shi (JP); Akinobu Hirayama, Mishima-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/951,669

(22) Filed: Dec. 6, 2007

(30) Foreign Application Priority Data
Dec. 11, 2006 (JP) 2006-332739

(51) Int. Cl. G03G 21/18

(52) U.S. Cl. 399/113

(57) ABSTRACT

A process cartridge in which before use, the separation of a predetermined distance between a charging roller and a photosensitive drum can be maintained, and in use, the separation state of the charging roller can be released without increasing the burden of a user. The process cartridge includes a charging roller separation member moveable between the first position to hold the separation of the charging roller from the photosensitive drum and the second position to abut the charging roller on the photosensitive drum. One of a photosensitive member unit and a developing unit includes a hook portion holding the separation member in the first position, and the other includes a hook portion that releases the separation member from the hook portion to move the separation member to the second position when the developing unit is pivoted.

### BACKGROUND OF THE INVENTION

1. Field of the Invention

The present invention relates to a process cartridge detachably mountable to an electrophotographic image forming apparatus such as an electrophotographic copying machine and an electrophotographic printer.

Here, the electrophotographic image forming apparatus forms an image on a recording sheet using an electrophotographic image forming method, and examples of the electrophotographic image forming apparatus include an electrophotographic copying machine, an electrophotographic printer (for example, a laser beam printer and an LED printer), a facsimile machine and a word processor.

Furthermore, a process cartridge is a cartridge into which at least one of a charging member, a developing unit and a cleaning unit, and an electrophotographic photosensitive member are integrally incorporated, the cartridge being detachably mountable to a main body of an image forming apparatus.

2. Description of the Related Art

Conventionally, as an electrophotographic image forming apparatus, there is a color electrophotographic image forming apparatus of an in-line type in which a plurality of process cartridges are aligned. There is a contact development method of performing a development in the state in which a developing roller forming a process cartridge is in contact with a photosensitive drum. In this method, in order to keep a predetermined contact pressure between the developing roller and the photosensitive drum during an image formation, the developing roller is urged against the photosensitive drum.

In the case of this method, when the process cartridge is not used for a long time period in the state of being mounted on the image forming apparatus main body, there is a possibility that an elastic layer of the developing roller is permanently deformed. Whereby, an uneven image may be formed at the time of development.

Then, proposed is a process cartridge and an image forming apparatus in which there is provided a mechanism of separating a developing roller from a photosensitive drum in the case of performing no image forming operation (Japanese Patent No. 2900530 (which is matured from Japanese Patent Application Laid-Open No. H04-43378) and Japanese Patent Application Laid-open No. 2001-337511).

Whereas, the construction in which a charging roller serving as a charging member is abutted on a photosensitive drum for charging the photosensitive drum is widely used. In such a contact charging, since the charging roller needs to be disposed reliably in contact with the photosensitive drum surface, the charging roller is in pressure contact with the photosensitive drum surface at a predetermined contact pressure. When the state of not being used for a long time period in this state continues, the elastic layer of the charging roller is permanently deformed, and thus an uneven density of an image of the cycle of the charging roller occurs.

Thus, proposed is a method in which an insert member for separating the charging roller from the photosensitive drum is inserted into therebetween at the time of shipment of a process cartridge, and a user removes the insert member in use (Japanese Patent Application Laid-Open No. H05-188667).

Alternatively, proposed is a process cartridge having a mechanism in which a charging roller having been separated until then is brought into abutment with a photosensitive drum when the process cartridge is mounted on the image forming apparatus main body (Japanese Patent Application Laid-Open No. H06-273987 and Japanese Patent Application Laid-Open No. 2000-181328).

### SUMMARY OF THE INVENTION

The present invention is to provide a process cartridge and an image forming apparatus, being improvements of the above-described inventions. That is, according to the present invention, before use, a charging member can be separated from an electrophotographic photosensitive member, and in use, the separation state of the charging member can be released without the increase of the burden of a user.

In addition, the present invention is to provide a process cartridge comprising: a photosensitive member unit including an electrophotographic photosensitive member; a developing unit movable relatively with respect to the photosensitive member unit, and including a developing roller developing an electrostatic latent image formed on the electrophotographic photosensitive member; a charging member charging the electrophotographic photosensitive member; and a separation member movable between a first position to separate the charging member from the electrophotographic photosensitive member and a second position to abut the charging member on the electrophotographic photosensitive member, wherein the separation member includes an engaging portion engaging with the photosensitive member unit to position the separation member in the first position and a force receiving portion receiving a force from the developing unit for releasing an engagement between the photosensitive member unit and the engaging portion to move the separation member to the second position when the developing unit is moved relatively with respect to the photosensitive member unit.

Moreover, the present invention is to provide a process cartridge comprising: a photosensitive member unit including an electrophotographic photosensitive member; a developing unit movable relatively with respect to the photosensitive member unit, and including a developing roller developing an electrostatic latent image formed on the electrophotographic photosensitive member; a charging member charging the electrophotographic photosensitive member; and a separation member movable between a first position to separate the charging member from the electrophotographic photosensitive member and a second position to abut the charging member on the electrophotographic photosensitive member, wherein the separation member includes an engaging portion engaging with the developing unit to position the separation member in the first position; and a force receiving portion receiving a force from the photosensitive member unit for releasing an engagement between the developing unit and the engaging portion to move the separation member to the second position when the developing unit is moved relatively with respect to the photosensitive member unit.

### BRIEF DESCRIPTION OF THE DRAWINGS

FIG. 1 is an overall schematic view of an image forming apparatus according to a first embodiment.

FIG. 2 is a sectional schematic view of a process cartridge.

FIG. 3 is a perspective view illustrating a connection construction of the process cartridge.

FIG. 4 is a perspective view illustrating a mounting aspect of the process cartridge onto the image forming apparatus main body.

FIG. 5A is a sectional view illustrating mounting of the process cartridge onto the image forming apparatus main body in the state in which a developing roller is separated from a photosensitive drum.

FIG. 5B is a sectional view illustrating a mounting aspect of the process cartridge onto the image forming apparatus main body in the state in which the developing roller is abutted on the photosensitive drum.

FIG. 6A is a sectional view illustrating a mounting construction of the process cartridge in which the engagement of a separation hook is made, onto the image forming apparatus main body.

FIG. 6B is a sectional view illustrating the construction of releasing the engagement of the separation hook.

FIG. 7 is a partial sectional view of the process cartridge illustrating a charging roller.

FIG. 8 is a partially sectional perspective view of the process cartridge illustrating a charging roller separation member.

FIG. 9 is a sectional view of the process cartridge.

FIG. 10 is a partially perspective view of the charging roller separation member.

FIGS. 11A and 11B are sectional views of the process cartridge.

FIG. 12 is a partially perspective view of the charging roller separation member.

FIG. 13 is a side view of a charging roller separation member according to a second embodiment.

FIG. 14A is a partially sectional perspective view illustrating a charging roller separation member according to a third embodiment.

FIG. 14B is a sectional view illustrating the charging roller separation member according to the third embodiment.

FIG. 15A is a partially enlarged view illustrating a hole shape of a support portion of the charging roller separation member according to the third embodiment.

FIG. 15B is a partially enlarged view illustrating a hole shape of a support portion of another charging roller separation member.

FIG. 16 is a side view of a charging roller separation member according to a fourth embodiment.

FIG. 17 is a side view of a charging roller separation member according to a fifth embodiment.

### DETAILED DESCRIPTION OF THE EMBODIMENTS

### First Embodiment

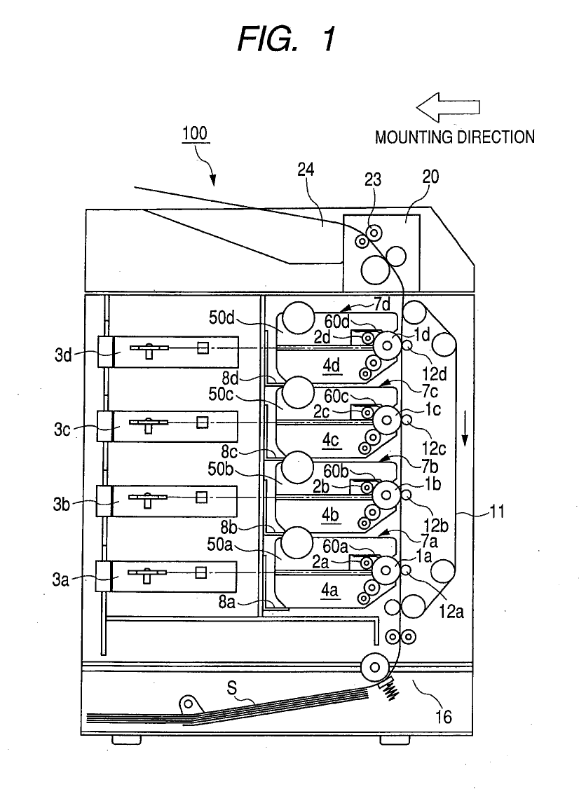

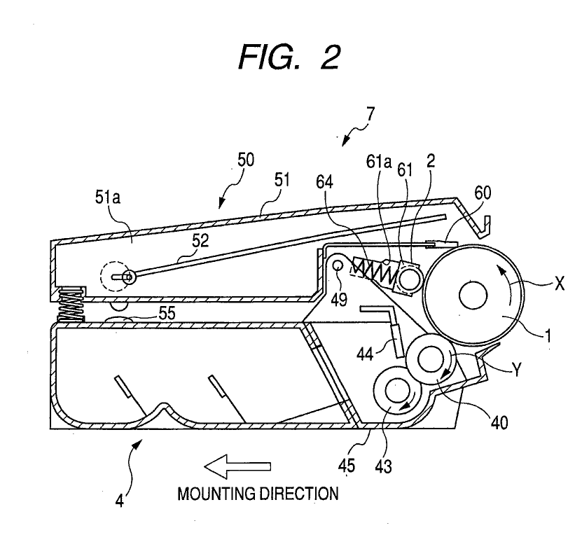

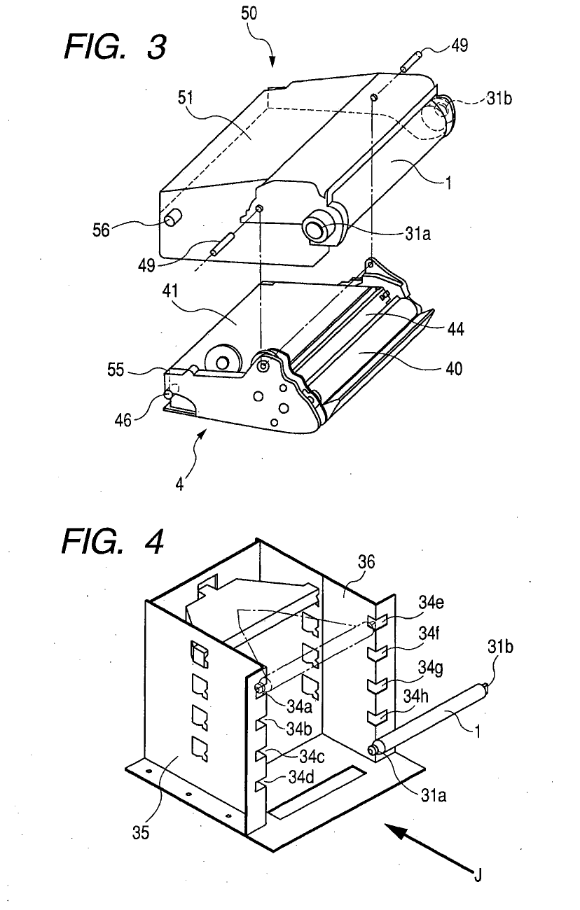

A first exemplary embodiment of a process cartridge and an image forming apparatus according to the present invention will be described referring to the drawings. FIG. 1 is an overall schematic view of a color electrophotographic image forming apparatus according to this embodiment. FIG. 2 is a sectional explanatory view of a process cartridge. FIG. 3 is a perspective view illustrating a connection construction of the process cartridge.

(Overall Construction of an Image Forming Apparatus)

First, the overall construction of the image forming apparatus will be described with reference to FIGS. 1 and 2. As illustrated in FIG. 1, an image forming apparatus main body 100 includes four process cartridge mounting portions 8 (8a, 8b, 8c, and 8d) arranged side-by-side in the vertical direction.

A cartridge 7 (7a, 7b, 7c, 7d) that is mounted at each mounting portion includes a photosensitive drum (electrophotographic photosensitive member) 1 (1a, 1b, 1c, 1d), being an image bearing member. Around the photosensitive drum 1, there are arranged in the order of mention in a rotation direction of the photosensitive drum 1, a charging roller 2 (2a, 2b, 2c, 2d), a scanner unit 3 (3a, 3b, 3c, 3d), a developing unit 4 (4a, 4b, 4c, 4d), a transfer roller 12 (12a, 12b, 12c, 12d), and a cleaning blade 60 (60a, 60b, 60c, 60d).

As illustrated in FIG. 2, the charging roller 2 serving as a charging member is abutted on the surface of the photosensitive drum 1 to uniformly charge the surface of the photosensitive drum 1. The scanner unit 3 applies a laser beam according to image information to form an electrostatic latent image on the photosensitive drum 1. The developing unit 4 develops the electrostatic latent image using a toner, being a developer to form a visible image (toner image). The transfer roller 12 is an electrostatic transfer unit causing the toner image on the photosensitive drum 1 to be transferred on a recording sheet S. The cleaning blade 60 is a cleaning unit removing the toner remaining on the surface of the photosensitive drum 1 after a transfer process.

An image forming operation in the above-mentioned image forming apparatus will be as follows.

First, the process cartridge 7 is sequentially driven in accordance with the timing of an image formation. Responsive to the drive of the process cartridge 7, the photosensitive drum 1 is driven to rotate in the direction indicated by an arrow X (in a counterclockwise direction in FIG. 2). Then, the scanner unit 3 corresponding to each process cartridge 7 is driven in sequence, and the charging roller 2 applies a uniform electric charge on the surface of the photosensitive drum 1. The scanner unit 3 makes an exposure according to an image signal on the surface of the photosensitive drum 1 to form an electrostatic latent image on the photosensitive drum 1. The electrostatic latent image having been formed is developed by the developing roller (developing member) 40.

On the other hand, the recording sheet S having been fed from a feeding portion 16 is conveyed between each photosensitive drum 1 and the associated transfer roller 12 by a transfer belt 11, and sequentially transferred with a toner image of each photosensitive drum 1. The recording sheet S having been transferred with the toner images of the four colors is separated from the transfer belt 11 and conveyed to a fixing portion 20. The recording sheet S having been conveyed to the fixing portion 20, after the toner image has been fixed by heating, is discharged out of the main body from a discharge portion 24 by a discharge roller 23.

(Process Cartridge)

Now, the process cartridge 7 will be described. In this embodiment, the process cartridges 7a to 7d have the same construction. The process cartridges 7a to 7d contain toners of yellow, magenta, cyan and black, respectively.

As illustrated in FIGS. 2 and 3, the process cartridge 7 (7a to 7d) is constructed to be an integral cartridge into which the photosensitive member unit 50 (50a to 50d) and the developing unit 4 (4a to 4d) are incorporated.

The photosensitive member unit 50 includes the photosensitive drum 1, the charging roller 2, the cleaning blade 60, a photosensitive member frame 51, and a removed toner chamber 51a. The photosensitive drum 1 is rotatably attached to the photosensitive member frame 51 via bearings 31a, 31b. The removed toner camber 51a is provided at the rear of the photosensitive member frame 51. The remaining toner having been removed by the cleaning blade 60 is fed to the removed toner chamber 51a by a toner feed mechanism 52.

The developing unit 4 includes a developing roller 40 and a developing frame 45. A toner containing portion 41 is provided in the developing frame 45. Each toner containing portion 41 contains a toner of each color. In the developing frame 45, the developing roller 40 is rotatably supported so as to be opposed to the photosensitive drum 1.

There are disposed on the circumference of the developing roller 40 a toner feed roller 43 and a developing blade 44. The developing roller 40 is rotated in the direction indicated by an arrow Y (refer to FIG. 2) in contact with the photosensitive drum 1 to carry and convey the toner.

As illustrated in FIG. 3, the developing unit 4 is pivotally coupled to the photosensitive member unit 50 with a developing unit pivot shaft 49 being a pivot center. The developing unit 4 can be relatively moved (can be pivoted) with respect to the photosensitive member unit 50.

The developing unit 4 is urged with the pivot shaft 49 being the center such that the developing roller 40 is contacted with the photosensitive drum 1.

(Mounting of the Process Cartridge onto the Image Forming Apparatus Main Body)

Now, mounting of the process cartridge 7 onto the apparatus main body 100 will be described. FIG. 4 is a perspective view of the apparatus main body 100 when the process cartridge 7 is mounted on the apparatus main body 100.

The process cartridge 7 is detachably mountable to the image forming apparatus main body. As illustrated in FIG. 4, the process cartridge 7 is mounted in the direction indicated by an arrow J with respect to the apparatus main body 100. Then, the bearings 31 (31a and 31b) that support the photosensitive drum 1 are inserted along guide grooves 34a to 34h of the apparatus main body 100. Further, owing to that the bearings 31 are pressed against the guide grooves 34, the position of the process cartridge 7 with respect to the apparatus main body 100 is determined.

(Developing Separation Construction of the Process Cartridge)

Now, the separation construction between the photosensitive drum 1 and the developing roller 40 in the process cartridge 7 will be described using FIGS. 3, 4, 5A and 5B.

The photosensitive member unit 50 includes regulating portions 56 on both side faces, and the apparatus main body 100 includes engaging portions 85 on both side plates 35 and 36. In the state in which the process cartridge 7 is inserted in the apparatus main body 100, the engaging portion 85 is engaged with the regulating portion 56 to regulate the upward movement of the photosensitive member unit 50.

There is provided integrally at the rear of the developing unit 4 (on the toner conveying upstream side of the toner containing portion 41) a force receiving portion 46. The apparatus main body 100 includes a cam 80 serving as a separation unit. At the rear of the developing unit 4, between the photosensitive member unit 50 and the developing unit 4, there is provided a spring 54, being an urging member. The spring 54 provides an urging force between the photosensitive member unit 50 and the developing unit 4 so as to urge the developing roller 40 to the photosensitive drum 1. That is, the spring 54 urges the rear side of the developing unit 4 in the direction of being separated from the photosensitive member frame 51.

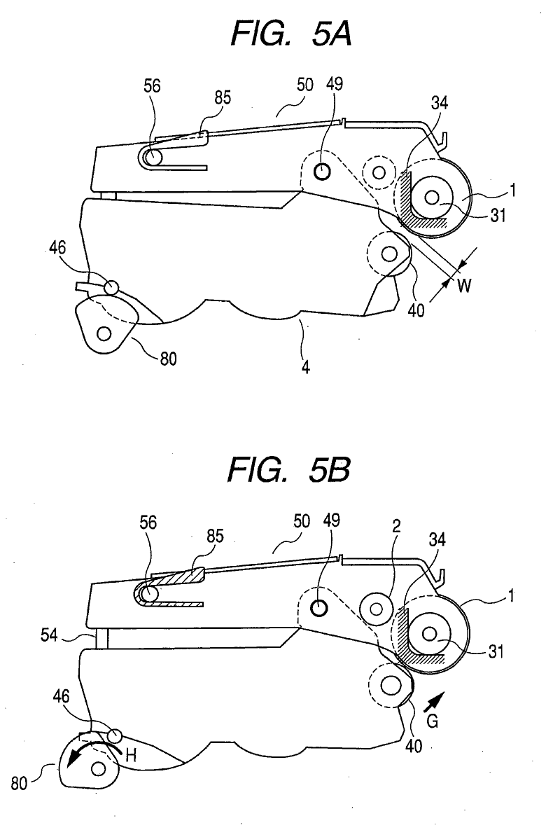

As illustrated in FIG. 5A, due to that the cam 80 is rotated to push the force receiving portion 46 up, the developing unit 4 is rotated about the pivot shaft 49. Then, the developing roller 40 is brought in the state of being separated from the photosensitive drum 1 by a predetermined gap W.

As illustrated in FIG. 5B, at the time of forming an image, by the rotation of the cam 80 in the direction indicated by an arrow H, the pressure on the force receiving portion 46 is released, and the developing unit 4 is rotated about the pivot shaft 49. Then, the developing roller 40 and the photosensitive drum 1 abut against each other at a predetermined pressure.

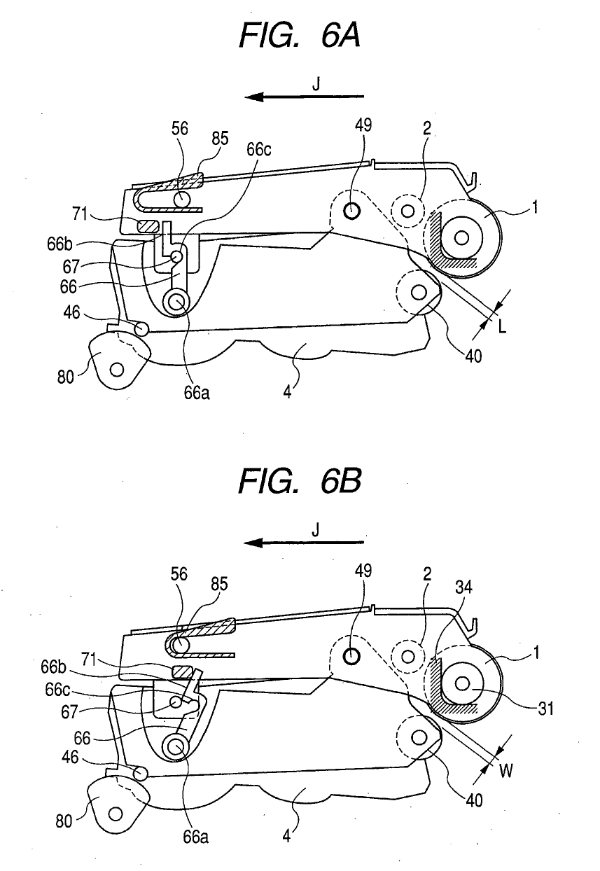

Now, the construction of developing separation in the state before the cartridge is mounted on the image forming apparatus main body will be described with reference to FIGS. 6A and 6B.

As illustrated in FIGS. 6A and 6B, the developing unit 4 is provided with a separation hook 66 pivotally about a pivot shaft 66a. There are provided at the distal end of the separation hook 66 a convex portion 66b and a concave portion 66c. There is provided at the photosensitive member frame 51a protrusion 67 to be engaged with the concave portion 66c.

As illustrated in FIG. 6A, in the state in which the process cartridge 7 is not used (new one), the process cartridge 7 is shipped in the state in which the concave portion 66c is engaged with the protrusion 67, being in the state in which the developing roller 40 is separated from the photosensitive drum 1 by a predetermined gap L. Here, the position of the developing unit 4 in the state in which the developing roller 40 and the photosensitive drum 1 are separated is referred to as a separation position.

As illustrated in FIG. 6B, when the process cartridge 7 is mounted on the image forming apparatus main body 100, a protrusion 71 that is provided at the image forming apparatus main body 100 is abutted on the convex portion 66b, and the separation hook 66 is rotated about the pivot shaft 66a. Whereby, the engagement between the concave portion 66c and the protrusion 67 is released. With the arrangement, the developing roller 40 and the photosensitive drum 1 are brought into contact with each other. Here, the position of the developing unit 4 in the sate in which the developing roller 40 and the photosensitive drum 1 are contacted with each other is referred to as a contact position.

Now, the separation construction of the charging roller 2 will be described.

(Charging Roller)

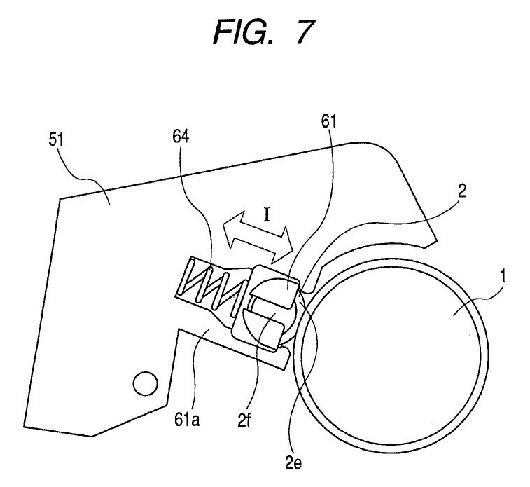

First, the charging roller 2 and the support construction of the charging roller 2 will be described. FIG. 7 is a partially sectional view of the process cartridge 7 looking from the side face in the axial direction of the charging roller 2. As illustrated in FIG. 7, the charging roller 2 is constructed to be formed with a conductive rubber member (elastic layer) 2e around a cored bar (shaft portion) 2f. The charging roller 2 is rotatably supported by a bearing 61. The bearing 61 is supported in a guide portion 61a of the photosensitive member frame 51. That is, the photosensitive member frame 51 rotatably supports the charging roller 2. The bearing 61 can slide in the guide portion 61a, and the charging roller 2 can be moved in directions indicated by a two-headed arrow I in FIG. 7 (in the directions of being abutted or separated with respect to the photosensitive drum 1). That is, the charging roller 2 can be moved between the abutment position of being abutted on the photosensitive drum 1 and the separation position of being separated from the photosensitive drum 1. The charging roller 2 is pressed against the photosensitive drum 1 by a compression spring (urging member) 64 via the charging roller bearing 61.

(Charging Roller Separation Member)

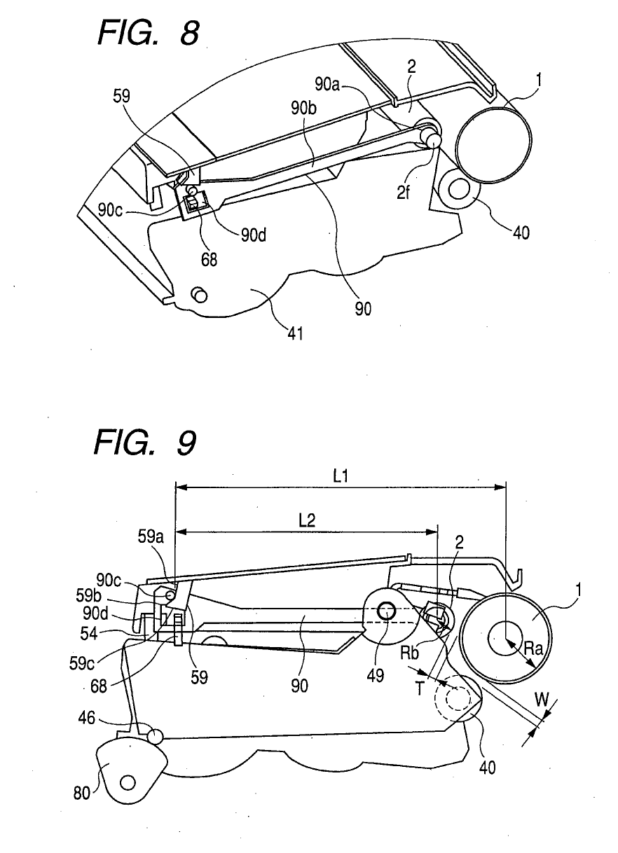

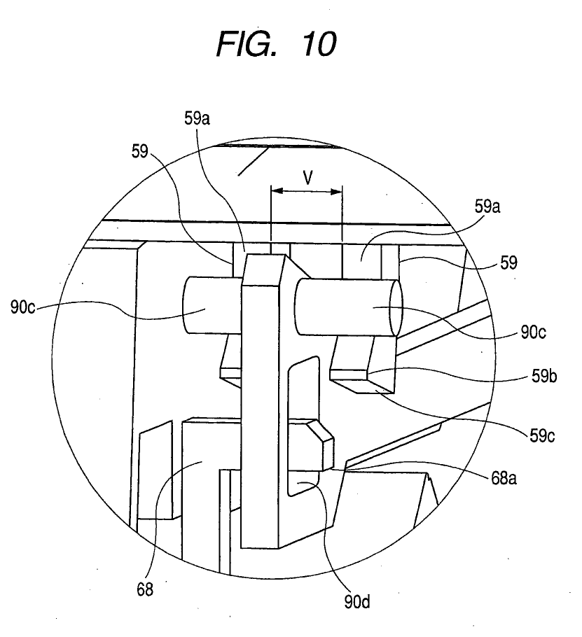

A charging roller separation member 90 of making a separation of the charging roller 2 will be described. FIG. 8 is a sectional perspective view at one end portion (in the vicinity of a bearing support) of the charging roller 2. FIG. 10 is a partial perspective view at one end portion of the separation member 90. Incidentally, in this embodiment, although one end portion of the charging roller 2 will be described as a matter of convenience, the charging roller 2 is in the same construction at both end portions.

As illustrated in FIG. 8, the separation member 90 includes a shaft holding portion 90a at one end of a connection portion 90b, and includes a protrusion 90c serving as an engaging portion and a release hole 90d serving as a force receiving portion, at the other end. At the underside of the photosensitive member frame 51, a hook portion 59 serving as an engaged portion is hung down. That is, the hook portion 59 is a part of the photosensitive member frame 51. In addition, at the toner containing portion 41, a hook portion 68 serving as a force applying portion is erected. That is, the hook portion 68 is a part of the developing frame 45.

The shaft holding portion 90a holds the cored bar 2f of the charging roller 2.

The protrusion 90c is formed to be in the same convex shape on both side faces of the separation member 90, and can be engaged with the hook portion 59. The protrusion 90c is held in the photosensitive member frame 51 in the state of being engaged with the hook portion 59.

As illustrated in FIG. 10, the release hole 90d is formed to be a hole through which a claw 68a of the hook portion 68 gets, and which can be engaged with the hook portion 68.

The separation member 90 can be moved between the first position in which the charging roller 2 is held in the state of being separated from the photosensitive drum 1 and the second position in which the charging roller 2 is abutted on the photosensitive drum 1.

The hook portion 59, by the engagement with the protrusion 90c, holds the separation member 90 in the first position. Whereby, the state in which the charging roller 2 is separated from the photosensitive drum 1 is maintained. At this time, the separation member 90 is positioned in the first position against the urging force of the compression spring 64. Further, the hook portion 68, when the developing unit 4 is pivoted (that is, the developing unit is relatively moved with respect to the photosensitive member unit 50), urges the release hole 90d. In other words, the release hole 90d is applied with the force from the hook portion 68. Whereby, the separation member 90 is released from being held by the hook portion 59. As a result, the separation member 90 is moved to the second position. That is, the separation member 90 is in the state of being at least engaged with the hook portion 59 in the first position, and in the state of being disengaged from the hook portion 59 in the second position.

(Construction of Holding Separation of the Charging Roller)

Now, the construction of holding the separation of the charging roller 2 will be described. FIG. 9 is a sectional view of the process cartridge 7 in the state in which the developing roller 40 and the charging roller 2 are separated from the photosensitive drum 1.

As illustrated in FIG. 9, the hook portion 59 includes a holding portion 59a, a hooking portion 59b and a slide portion 59c.

The holding portion 59a is a face of holding the separation member 90. The hooking portion 59b is formed upward at the lower end of the hook portion 59 and hooks the protrusion 90c to hold the separation member 90. The slide portion 59c is a face inclined diagonally upward such that the protrusion 90c can slide in contact.

As illustrated in FIG. 10, the hook portion 59 is disposed at two points with a space V therebetween in the longitudinal direction of the process cartridge 7. The other end of the separation member 90 can move between two hook portions 59 disposed with the space V therebetween.

The separation member 90 is pulled in the separation direction to separate the charging roller 2 from the photosensitive drum 1. Owing to that the protrusion 90c is hooked on the hook portion 59 to be engaged in this state (in the first position), the charging roller 2 is held in the separation state in which the charging roller 2 is separated from the photosensitive drum 1.

A separation amount T between the photosensitive drum 1 and the charging roller 2 is determined by a distance L2 between an outer diameter portion of the protrusion 90c and the center of the charging roller, a distance L1 between the center of the photosensitive drum 1 and the holding portion 59a, a radius Ra of the photosensitive drum 1, and a radius Rb of the charging roller 2.

(Construction of Releasing the Charging Roller from Being Held in Separation)

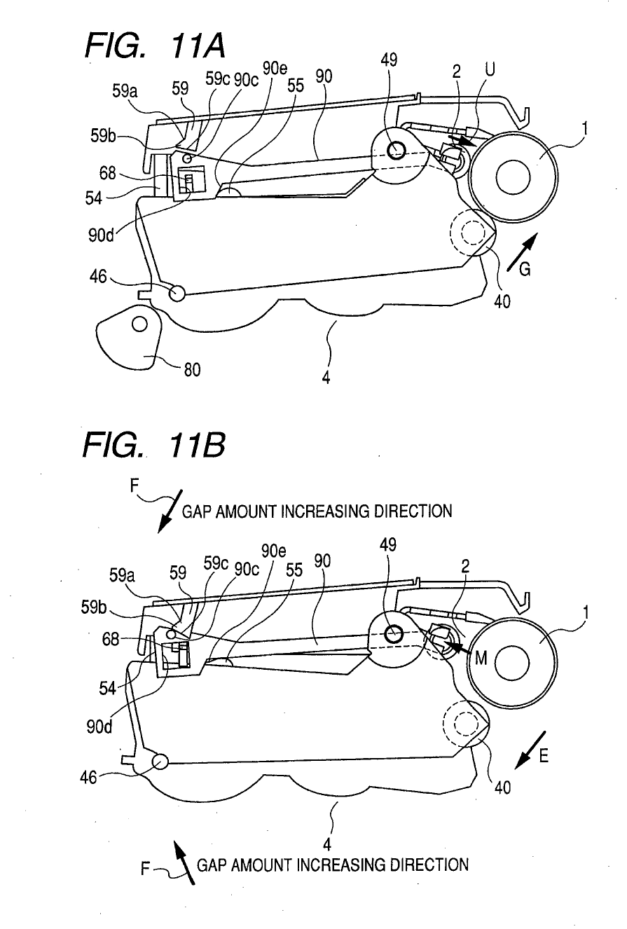

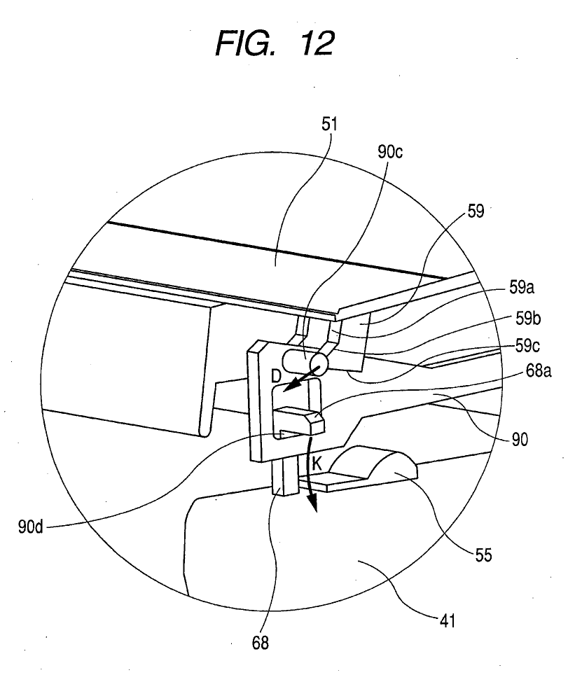

Now, the construction of releasing the separation state of the charging roller will be described. FIGS. 11A and 11B are explanatory views of the method of releasing the separation state of the charging roller. FIG. 12 is a partial perspective view of the separation member 90 and the toner containing portion 41.

In the separation state of the charging roller 2, the protrusion 90c is hooked on the hook portion 59 to be engaged.

When the toner containing portion 41 is rotated in the direction indicated by an arrow G in FIG. 11A about the pivot shaft 49, the developing roller 40 is contacted with the photosensitive drum 1 to be brought into the abutment state from the separation state.

In association with this pivotal movement of the toner containing portion 41 in the direction indicated by the arrow G, the hook portion 68 is rotated in the direction indicated by an arrow K in FIG. 12. Owing to that the hook portion 68 is rotated, the claw 68a is engaged with the release hole 90d. The claw 68a that is engaged with the release hole 90d is further rotated in the direction indicated by the arrow K. Whereby, the claw 68a presses the release hole 90d in the direction indicated by the arrow K, and the release hole 90d is applied with the force in the direction indicated by the arrow K.

With the arrangement, the protrusion 90c is moved in the direction indicated by an arrow D in FIG. 12 from the holding portion 59a, gets over the hooking portion 59b, and releases the engagement between the separation member 90 and the hook portion 59. In the state in which the engagement is released, the separation member 90 and the charging roller 2 are moved in the direction of being abutted on the photosensitive drum 1 by the urging force provided by the compression spring 64, and thus the charging roller 2 and the photosensitive drum 1 are brought into contact with each other at a predetermined pressure. At this time, the separation member 90 is in the second position.

(Construction of Separating the Charging Roller 2 Again)

Next, in the case where the charging roller 2 needs to be separated again, the separation member 90 is returned to the first position from the second position, and thus the charging roller 2 and the photosensitive drum 1 are separated from each other and held in the separation state.

As illustrated in FIG. 11A, the developing unit 4 includes a protrusion 55 in the position of being opposed to the separation member 90. The separation member 90 is provided with a receiving face 90e that can abut on the protrusion 55. The protrusion 55 is formed in the position of not pushing the separation member 90 up even if the developing unit 4 is rotated by the cam 80.

In the above-mentioned construction, for example, as illustrated in FIG. 11B, the process cartridge 7 is removed from the image forming apparatus main body, and the rear side of the process cartridge is pressed (in the directions indicated by the arrows F). Whereby, the developing unit 4 is rotated more than usual with respect to the photosensitive member unit 50, the separation amount between the photosensitive drum 1 and the developing roller 40 is made to be larger than normal.

Here, the rear side of the process cartridge is the side opposed to the photosensitive drum side with respect to the pivot shaft 49 as the pivot center. Furthermore, a normal separation amount is the separation amount between the developing roller 40 and the photosensitive drum 1 when the developing unit 4 is rotated by the cam 80.

When the separation amount is made larger than normal, the protrusion 55 serving as a return portion applies a force to the receiving face 90e of the separation member 90, and pushes up the separation member 90. When the separation member 90 is pushed up, the protrusion 90c is abutted on the slide portion 59c.

From this state, the developing unit 4 is rotated in the direction of separating the developing roller 40 further. Whereby, the protrusion 90c is moved along the slide portion 59c, and the separation member 90 is moved in the separation direction. With the arrangement, the charging roller 2 is moved in the direction indicated by an arrow M in FIG. 11B, and separated from the photosensitive drum 1.

Thereafter, the protrusion 90c gets over the hooking portion 59b of the hook portion 59, and held in the position of being abutted on the holding portion 59a. That is, the separation member 90 is returned to the first position, and the charging roller 2 is held in the separation sate of being separated with respect to the photosensitive drum 1 by the predetermined separation amount T again.

(Advantage)

In the above-described construction, before use, the separation of a predetermined distance of the charging roller from the photosensitive drum 1 can be kept, and in use, the separation state of the charging roller can be released without the increase of the burden of a user.

In specific, at the time of shipment of the process cartridge, the separation member 90 and the hook portion 59 are brought in the state of being engaged with each other. Whereby, the charging roller 2 is held in the state of being separated with respect to the photosensitive drum 1 (in the first position). Therefore, an uneven image due to a permanent deformation of the rubber member 2e or the generation of traversal streaks on an image of a roller cycle due to rubbing or sliding between the photosensitive drum 1 and the charging roller 2 by the vibration in a physical distribution can be reduced.

In use of the process cartridge, the engagement between the separation member 90 and the hook portion 59 is released by the pivotal movement of the developing unit 4 accompanied by an abutment movement of the developing roller 40. Therefore, without troubling a user, the charging roller 2 is released from being held in separation, and thus the charging roller 2 can be abutted on the photosensitive drum 1.

### Second Embodiment

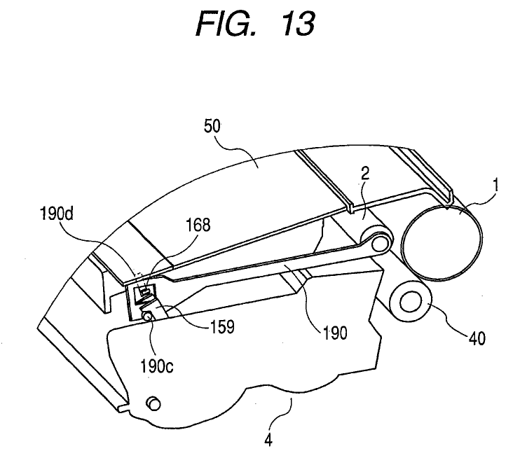

Now, a second embodiment of a process cartridge and an image forming apparatus according to the present invention will be described referring to the drawings. FIG. 13 is a schematic side view of a separation member according to this embodiment. Portions which description is a duplication of that of the above-mentioned first embodiment will be designated with like reference numerals to omit descriptions thereof.

As illustrated in FIG. 13, in the process cartridge and the image forming apparatus according to this embodiment, there are provided a charging roller separation member 190 and hook portions 159, 168 instead of the separation member 90 and the hook portions 59, 68 according to the above-mentioned first embodiment.

In the separation member 190, the protrusion 90c and the release hole 90d of the separation member 90 are positioned inverted. That is, on the underside of the photosensitive member frame 51, the hook portion 168 is hung down. In addition, on the toner containing portion 41, the hook portion 159 is erected. Further, the protrusion 55 according to the first embodiment is also provided at the photosensitive member frame 51 (not illustrated).

In the above-mentioned construction, by the engagement between the hook portion 159 and the protrusion 190c of the separation member 190, the separation member 190 is held in the first position, being the state in which the charging roller 2 and the photosensitive drum 1 are separated. Moreover, by the pivotal movement of the developing unit 4, the engagement between the protrusion 190c and the hook portion 159 is released by the hook portion 168, thus enabling to be in the second position, being the state in which the charging roller 2 and the photosensitive drum 1 are abutted on each other.

Owing to such construction as described above, the same advantage as is the above-mentioned first embodiment can be obtained.

### Third Embodiment

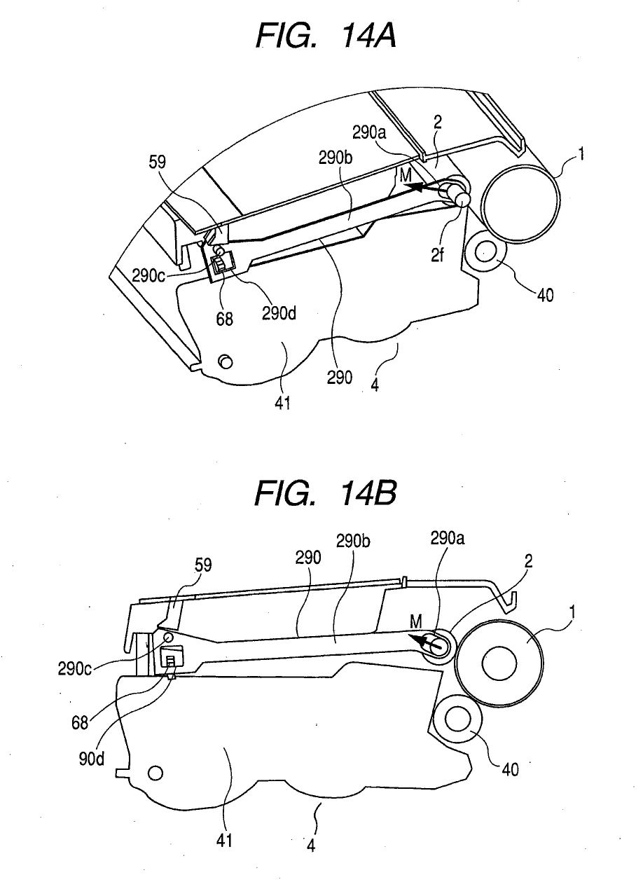

Now, a third embodiment of a process cartridge and an image forming apparatus according to the present invention will be described referring to the drawings. FIGS. 14A and 14B are schematic side views of a charging roller separation member according to this embodiment. Portions which description is a duplication of that of the above-mentioned first embodiment will be designated with like reference numerals to omit descriptions thereof.

As illustrated in FIGS. 14A and 14B, the process cartridge and the image forming apparatus according to this embodiment are provided with a charging roller separation member 290 instead of the separation member 90 according to the above-mentioned first embodiment.

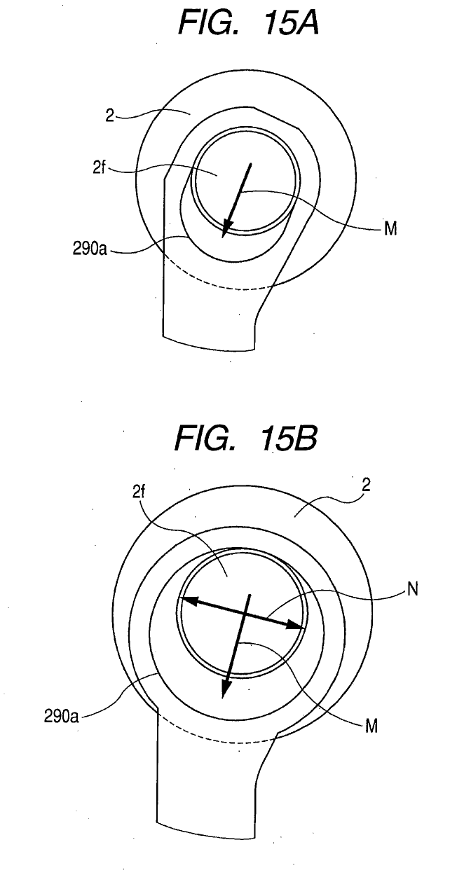

As illustrated in FIG. 15A, the separation member 290 is provided with a shaft holding portion 290a of an elongated hole shape of elongating the shaft holding portion 90a of the separation member 90 in the separation direction (in the direction indicated by an arrow M) opposite to the urging direction of the charging roller 2.

In the case where the process cartridge 7 is applied with an impact in the separation direction (in the direction indicated by the arrow M) in the state in which the charging roller 2 is separated from the photosensitive drum 1, the charging roller 2 is moved in the separation direction as well. However, the cored bar 2f is slid in the shaft holding portion 290a. Whereby, even if the charging roller 2 is moved, it can be suppressed that a protrusion 290c of the separation member 290 is released from the hook portion 59, and the separation between the charging roller 2 and the photosensitive drum 1 is released.

That is, even when the process cartridge 7 is applied with the impact e.g., at the time of physical distribution, the separation state between the charging roller 2 and the photosensitive drum 1 is ensured, thus enabling to suppress the occurrence of the uneven density of an image due to the permanent deformation of the elastic layer of the charging roller 2.

Incidentally, the shape of the shaft holding portion 290a is not limited to the above-mentioned rectangular shape, but the shaft holding portion 290a has only to include a gap in the direction opposite to the urging direction of urging the charging roller 2 to the photosensitive drum 1 (in the direction indicated by the arrow M). That is, the shaft holding portion 290a just has to be so shaped that the cored bar 2f can slide in the separation direction in the shaft holding portion 290a from the state in which the charging roller 2 is separated from the photosensitive drum 1. For example, as illustrated in FIG. 15B, it has only to be a circular shape larger than the shaft diameter of the charging roller 2.

Since the charging roller 2 is held in a bearing 61, the charging roller 2 is not pivoted in the direction intersected with the urging direction (in the direction indicated by an arrow N). Therefore, originally, the charging roller 2 is never pivoted in the direction intersected with the separation direction. However, in the case where there is looseness or play at the bearing 61 or the mounting portion of the bearing 61, there are some cases of the occurrence of a pivotal movement of this looseness. In this construction, the influence of the charging roller 2 on the separation member 290 owing to this looseness can be reduced. Furthermore, since the gap between the shaft holding portion 290a and the charging roller shaft 2f can be made larger, the resistance with respect to the movement of following the photosensitive drum 1 of the charging roller 2 by the separation member 290 can be reduced.

Although the separation member 290 according to this embodiment is described instead of the separation member 90 according to the first embodiment, it is applicable instead of the separation member 190 according to the second embodiment.

### Fourth Embodiment

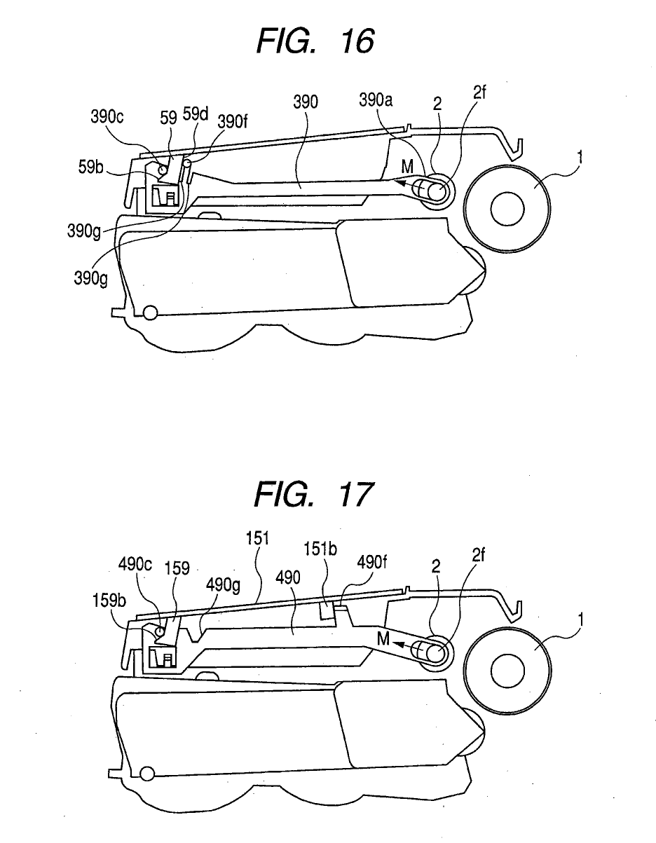

Now, a fourth embodiment of a process cartridge and an image forming apparatus according to the present invention will be described referring to the drawings. FIG. 16 is a schematic side view of a charging roller separation member according to this embodiment. Portions which description is a duplication of that of the above-mentioned first embodiment will be designated with like reference numerals to omit descriptions thereof.

As illustrated in FIG. 16, the process cartridge and the image forming apparatus according to this embodiment are provided with a charging roller separation member 390 instead of the charging roller separation member 90 according to the above-mentioned first embodiment.

The separation member 390 includes a shaft holding portion 390a of an elongated hole shape of being elongated in the separation direction (in the direction indicated by an arrow M) opposite to the urging direction of urging the charging roller 2 to the photosensitive drum 1, and a regulating portion 390f of regulating the movement of the separation member 390 on the occasion of moving in the separation direction. Here, the regulating portion 390f is provided so as to be proximate to a regulating portion receiving face 59d of a hook portion 59 of the photosensitive member frame 51 when the charging roller 2 is in the state of being separated from the photosensitive drum 1.

There are some cases where the process cartridge 7 is applied with an impact in the separation direction (in the direction indicated by the arrow M) in the state in which the charging roller 2 is separated from the photosensitive drum 1 at the time of physical distribution of the process cartridge. In this case, the charging roller 2 is moved in the separation direction, the cored bar 2f is also slid in the shaft holding portion 390a, and the separation member 390 will lose the urging force that is provided from the compression spring 64 via the cored bar 2f. Then, the separation member 390 that loses the urging force tends to move in the separation direction by the impact as well. On this occasion, by the abutment between the regulating portion 390f and the regulating portion receiving face 59d, the movement of the separation member 390 in the separation direction can be regulated. Thus, it can be suppressed that a protrusion 390c is released from the hook portion 59 to release the separation between the charging roller 2 and the photosensitive drum 1.

That is, even when the process cartridge 7 is applied with an impact at the time of physical distribution, the separation state between the charging roller 2 and the photosensitive drum 1 is ensured. Whereby, the occurrence of an uneven density of an image due to a permanent deformation of the elastic layer of the charging roller 2 can be suppressed.

Incidentally, the regulating portion 390f is shaped to include a notch portion 390g at each end portion to have elasticity. With the arrangement, in the case of moving from the first position to the second position, due to that the regulating portion 390f is bent when the protrusion 390c gets over the hooking portion 59b of the hook portion 59, the engagement between the separation member 390 and the hook portion 59 can be released.

Incidentally, this embodiment is applicable even if the shaft holding portion 390a is not shaped to be an elongated hole. Furthermore, this embodiment is applicable to the second embodiment as well.

### Fifth Embodiment

Now, a fifth embodiment of a process cartridge and an image forming apparatus according to the present invention will be described referring to the drawings. FIG. 17 is a schematic side view of a charging roller separation member according to this embodiment. Portions which description is a duplication of that of the above-mentioned first embodiment will be designated with like reference numerals to omit descriptions thereof.

As illustrated in FIG. 17, in the process cartridge and the image forming apparatus according to this embodiment, there are provided a cleaning frame 151 instead of the photosensitive member frame 51 according to the above-mentioned first embodiment, and a charging roller separation member 490 instead of the charging roller separation member 90.

In the cleaning frame 151, as illustrated in FIG. 17, there is provided a regulating portion receiving portion 151b. In addition, the separation member 490 is provided with a regulating portion 490f and a notch portion 490g. Here, the regulating portion 490f is provided so as to be proximate to the regulating portion receiving portion 151b when the charging roller 2 is in the state of being separated from the photosensitive drum 1.

In the case where the process cartridge 7 is applied with an impact in the separation direction (in the direction indicated by the arrow M) in the state in which the charging roller 2 is separated from the photosensitive drum 1 at the time of physical distribution of the process cartridge, the charging roller 2, the cored bar 2f and the separation member 490 are applied with the impact in the separation direction as well. On this occasion, by the abutment of the regulating portion 490f of the separation member 490 against the regulating portion receiving portion 151b, the movement of the charging roller 2, the cored bar 2f and the separation member 490 in the separation direction can be regulated. Therefore, it can be suppressed that a protrusion 490c is released from the hook portion 159 to release the separation between the charging roller 2 and the photosensitive drum 1.

That is, even when the process cartridge 7 is applied with the impact at the time of physical distribution, the separation state between the charging roller 2 and the photosensitive drum 1 is ensured, and the occurrence of an uneven density of an image due to a permanent deformation of the elastic layer of the charging roller 2 can be suppressed.

Incidentally, in the case of moving from the first position to the second position, owing to that a notch portion 490g is bent when the protrusion 490c gets over a hooking portion 159b of the hook portion 159, the engagement between the separation member 490 and the hook portion 159 can be released.

Incidentally, even if the shaft holing portion according to this embodiment is shaped to be an elongated hole, this embodiment is applicable. Moreover, this embodiment is also applicable to the second embodiment. In addition, the regulating portion receiving portion 151b may be provided at the photosensitive member unit 50.

Furthermore, although in each of the above-mentioned embodiments, a charging roller is described as a charging member, any charging member to be contacted with an electrophotographic photosensitive member such as a charging blade may be employed.

According to the above-described embodiments, before use, a charging member can be separated from an electrophotographic photosensitive member, and in use, the separation state of the charging member can be released without the increase of the burden of a user.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-332739, filed Dec. 11, 2006, which is hereby incorporated by reference in its entirety.

What is claimed is:

1. A process cartridge detachably mountable to an electrophotographic image forming apparatus, the process cartridge comprising:
a photosensitive member unit including an electrophotographic photosensitive member;
a developing unit movable relatively with respect to the photosensitive member unit, and including a developing roller developing an electrostatic latent image formed on the electrophotographic photosensitive member;
a charging member charging the electrophotographic photosensitive member; and
a separation member movable between a first position to separate the charging member from the electrophotographic photosensitive member and a second position to abut the charging member on the electrophotographic photosensitive member,
wherein the separation member includes an engaging portion engaging with the photosensitive member unit to position the separation member in the first position and a force receiving portion receiving a force from the developing unit for releasing an engagement between the photosensitive member unit and the engaging portion to move the separation member to the second position when the developing unit is moved relatively with respect to the photosensitive member unit.

2. A process cartridge according to claim 1, further comprising a regulating portion receiving portion,
wherein the separation member includes a regulating portion, and
wherein the regulating portion is configured to abut on the regulating portion receiving portion to regulate a movement of the separation member in an opposite direction to an urging direction of urging the charging member to the electrophotographic photosensitive member when the separation member is positioned in the first position.

3. A process cartridge according to claim 1, wherein the separation member includes a shaft holding portion for holding a shaft of the charging member, and when the separation member is positioned in the first position, the shaft holding portion includes a gap in an opposite direction to an urging direction of urging the charging member to the electrophotographic photosensitive member.

4. A process cartridge according to claim 1, wherein the engaging portion is engaged with a part of a photosensitive member frame that rotatably supports the electrophotographic photosensitive member and the charging member, and the force receiving portion receives a force from a part of a developing frame that rotatably supports the developing roller.

5. A process cartridge according to claim 1, further comprising an urging member urging the charging member toward the electrophotographic photosensitive member, and the separation member is positioned in the first position against an urging force of the urging member.

6. A process cartridge according to claim 1, wherein the developing unit is provided with a return portion for urging the separation member in order to return the separation member from the second position to the first position.

7. A process cartridge according to claim 1, wherein the developing unit is moved relatively with respect to the photosensitive member unit so that the developing unit moves between a contact position to contact the developing roller with the electrophotographic photosensitive member and a separation position to separate the developing roller from the electrophotographic photosensitive member.

8. A process cartridge according to claim 7, wherein the developing unit is moved between the contact position and the separation position by receiving a force from the electrophotographic image forming apparatus.

9. A process cartridge detachably mountable to an electrophotographic image forming apparatus, the process cartridge comprising:
a photosensitive member unit including an electrophotographic photosensitive member;
a developing unit movable relatively with respect to the photosensitive member unit, and including a developing roller developing an electrostatic latent image formed on the electrophotographic photosensitive member;
a charging member charging the electrophotographic photosensitive member; and
a separation member movable between a first position to separate the charging member from the electrophotographic photosensitive member and a second position to abut the charging member on the electrophotographic photosensitive member,
wherein the separation member includes an engaging portion engaging with the developing unit in order to be positioned in the first position and a force receiving portion receiving a force from the photosensitive member unit for releasing an engagement between the developing unit and the engaging portion to move the separation member to the second position when the developing unit is moved relatively with respect to the photosensitive member unit.

10. A process cartridge according to claim 9, further comprising a regulating portion receiving portion,
wherein the separation member includes a regulating portion, and
wherein the regulating portion is configured to abut on the regulating portion receiving portion to regulate a movement of the separation member in an opposite direction to an urging direction of urging the charging member to the electrophotographic photosensitive member when the separation member is positioned in the first position.

11. A process cartridge according to claim 9, wherein the separation member includes a shaft holding portion for holding a shaft of the charging member, and when the separation member is positioned in the first position, the shaft holding portion includes a gap in an opposite direction to an urging direction of urging the charging member to the electrophotographic photosensitive member.

12. A process cartridge according to claim 9, wherein the engaging portion is engaged with a part of a developing frame that rotatably supports the developing roller, and the force receiving portion receives a force from a part of a photosensitive member frame that rotatably supports the electrophotographic photosensitive member and the charging member.

13. A process cartridge according to claim 9, further comprising an urging member urging the charging member toward the electrophotographic photosensitive member, and the separation member is positioned in the first position against an urging force of the urging member.

14. A process cartridge according to claim 9, wherein the photosensitive member unit is provided with a return portion for urging the separation member in order to return the separation member from the second position to the first position.

15. A process cartridge according to claim 9, wherein the developing unit is moved relatively with respect to the photosensitive member unit so that the developing unit moves between a contact position to contact the developing roller with the electrophotographic photosensitive member and a separation position to separate the developing roller from the electrophotographic photosensitive member.

16. A process cartridge according to claim 15, wherein the developing unit is moved between the contact position and the separation position by receiving a force from the electrophotographic image forming apparatus.
